(19) United States
(12) Patent Application Publication
(10) Pub. No.: US 2012/0049720 A1
(43) Pub. Date: Mar. 1, 2012

(54) SINGLE END TYPE LAMP

(75) Inventor: Yutaka YAMAMIZU, Hyogo-ken (JP)

(73) Assignee: USHIO DENKI KABUSHIKI KAISHA, Tokyo (JP)

(21) Appl. No.: 13/218,942

(22) Filed: Aug. 26, 2011

(30) Foreign Application Priority Data
Aug. 30, 2010 (JP) 2010-191775

(51) Int. Cl. H01J 5/50

(52) U.S. Cl. 313/318.01

(57) ABSTRACT

A single end type lamp comprising a light emitting tube with a sealing portion formed at one end thereof; a base secured at one end of the light emitting tube and accommodating and holding the sealing portion; a socket provided with a concave accommodating portion for removably accommodating and holding said base; wherein said concave accommodating portion is arranged in said socket such that said base can be inserted therein in a direction orthogonal to a tube axis of the light emitting tube, and the base is provided with an engaging portion engaging at least in the direction of the tube axis of the light emitting tube with an engaging part formed in said concave accommodating portion of said socket.

### BACKGROUND OF THE INVENTION

1. Field of the Invention

The present invention relates to single end type lamps.

2. Description of Related Art

Presently, single end type lamps such as halogen lamps wherein one end is sealed are widely used, for example, as light sources for the illumination of stages or for the illumination of concert halls or as light sources of devices for the heat treatment of semiconductor wafers. For such single end type lamps, lamps are known which are configured such that, as is shown for example in FIG. 12, a light emitting tube 71 with a sealing portion 72 formed at one end thereof is provided, a filament 75 is arranged therein along the tube axis C of the light emitting tube 71 and an inert gas containing, for example, nitrogen and a halogen compound are enclosed in the interior of the light emitting tube 71, and a base 80 accommodating and holding the sealing portion 72 is secured at one end of the light emitting tube 71 (see JP-A-2006-086020 and corresponding U.S. Pat. No. 7,385,340 B2). At the bottom part of the base 80 of this single end type lamp 70 two power supply pins 81 are formed such that they project to the outside in the direction of the tube axis, and these power supply pins 81 are attached at a socket 85 by insertion in the direction of the tube axis. When the single end type lamp 70 with said configuration is to be removed from the socket 85, the single end type lamp 70 has to be pulled out in the direction of the tube axis of the light emitting tube 71. But because often other structural elements such as other lamps or reflecting mirrors are present in the device (appliance) being provided with the single end type lamp 70, the problem that the lamp exchange operation becomes difficult and the problem of a breakage of the light emitting tube 71 because of an unexpected contact with another structural element when pulling out the single end type lamp 70 occurs.

### SUMMARY OF THE INVENTION

The present invention was made in view of the above mentioned circumstances and has the object to provide a single end type lamp which can be attached by inserting into a socket and is easily removable therefrom.

The single end type lamp of the present invention comprises a light emitting tube with a sealing portion formed at one end thereof; a base secured at one end of the light emitting tube and accommodating and holding the sealing portion; and a socket provided with a concave accommodating portion for removably accommodating and holding said base. Said concave accommodating portion is arranged in said socket such that said base can be inserted therein in a direction orthogonal to a tube axis of the light emitting tube, and the base is provided with an engaging part engaging at least in the direction of the tube axis of the light emitting tube with an engaging portion formed in said concave accommodating portion of said socket.

It is possible to configure the single end type lamp of the present invention such that said base is a flat cuboid, at least one portion at each of the flat front face and the flat back face thereof having a contact point plate to be positioned, wherein said engaging part consists of a convex part or of a concave part at each of said flat front face and said flat back face being formed such that it extends in a direction being orthogonal to the tube axis of said light emitting tube, and the attachment is made in a socket comprising an engaging portion consisting of a concave part or of a convex part having been formed such that it extends in the insertion direction of the lamp at each of the faces in the concave accommodating portion opposing the flat front face and the flat back face of the base.

Further, it is possible to configure the single end type lamp of the present invention such that the engaging part of said base consists of concave grooves being formed such that they extend in a direction orthogonal to the tube axis of said light emitting tube, and the attachment is made in a socket wherein an engaging portion consisting of a projecting strip engaging slidably with a concave groove of said base has been formed such that it extends in the insertion direction of the lamp at each of the faces in the concave accommodating portion opposing the flat front face and the flat back face of the base.

Further, it is possible to configure the single end type lamp of the present invention such that the engaging part of said base consists of projecting strips being formed such that they extend in a direction orthogonal to the tube axis of said light emitting tube, and the attachment is made in a socket wherein an engaging portion consisting of a concave groove engaging slidably with a projecting strip of said base has been formed such that it extends in the insertion direction of the lamp at each of the faces in the concave accommodating portion opposing the flat front face and the flat back face of the base.

Then, it is possible to configure the single end type lamp of the present invention such that said base is a flat cuboid, at least one portion at each of the flat front face and the flat back face thereof having a contact point plate to be positioned, wherein said engaging part consists of a convex part or of a concave part being formed in the insertion head face which is brought into contact with the bottom face of the concave accommodating portion of said socket, and the attachment is made in a socket wherein an engaging portion consisting of a concave part or of a convex part has been formed in the bottom face of said concave accommodating portion.

As, in the single end type lamp of the present invention, the engaging part of the base and the engaging portion of the concave accommodating portion of the socket are engaged at least in the direction of the tube axis of the light emitting tube by inserting the basis in a direction orthogonal to the tube axis of the light emitting tube into said concave accommodating portion of the socket being provided with the concave accommodating portion accommodating and holding the base, it suffices to move the single end type lamp in a direction orthogonal to the tube axis of the light emitting tube when attaching or removing the lamp. Therefore the single end type lamp can be attached easily at the socket.

By means of the configuration wherein an engaging part consisting of a concave part or of a convex part extending in a direction orthogonal to the tube axis of the light emitting tube is formed at each of the flat front face and the flat back face of a flat cuboid shaped base and the attachment is made in a socket comprising an engaging portion consisting of a convex part or of a concave part having been formed such that it extends in the insertion direction of the lamp at each of the faces in the concave accommodating portion opposing the flat front face and the flat back face of the base, and the concave parts or the convex parts of the base are engaged while being guided along the convex parts or the concave parts at the socket, it is possible to avoid rotations along the lateral axis of the lamp and in the plane along the flat front face (flat back face) so that the single end type lamp can be attached securely in the correct position.

Also with a configuration wherein an engaging part and an engaging portion are formed respectively at the insertion head face of the base and at the bottom face of the concave accommodating portion being brought into contact with the insertion head face of the base, the same results as mentioned above can be achieved, that is, the single end type lamp can be attached at the socket easily and securely in the correct position.

### BRIEF DESCRIPTION OF DRAWINGS

FIG. 1 is a front view schematically showing the configuration of an example of a single end type lamp of the present invention;

FIG. 2 is a schematic plan view of the single end type lamp shown in FIG. 1;

FIG. 3 is a schematic view of the right side of the single end type lamp shown in FIG. 1;

FIG. 4 is a section along A-A in FIG. 3;

FIG. 5 is a plan view schematically showing the configuration of the socket at which the single end type lamp of the present invention is attached;

FIG. 6 is a schematic side face view showing an outline of the configuration of the socket shown in FIG. 5 together with a base seen from one end side in the direction of the tube axis of the light emitting tube;

FIG. 7 is a plan view schematically showing the attachment state of the base and the socket;

FIG. 8 is a schematic end face view schematically showing the attachment condition of the base and the socket seen from one end side in the direction of the tube axis of the light emitting tube;

FIG. 9 is a schematic view to explain the method to remove the single end type lamp from the socket;

FIG. 10 is a front view schematically showing the configuration of another example of a single end type lamp of the present invention;

FIG. 11 is an oblique view schematically showing the configuration of still another example of the base of a single end lamp of the present invention; and

FIG. 12 is a sectional view schematically showing the configuration of an example of a known single end type lamp in the state of being attached at a socket.

### DETAILED DESCRIPTION OF THE INVENTION

Below, embodiments of the present invention will be explained in detail.

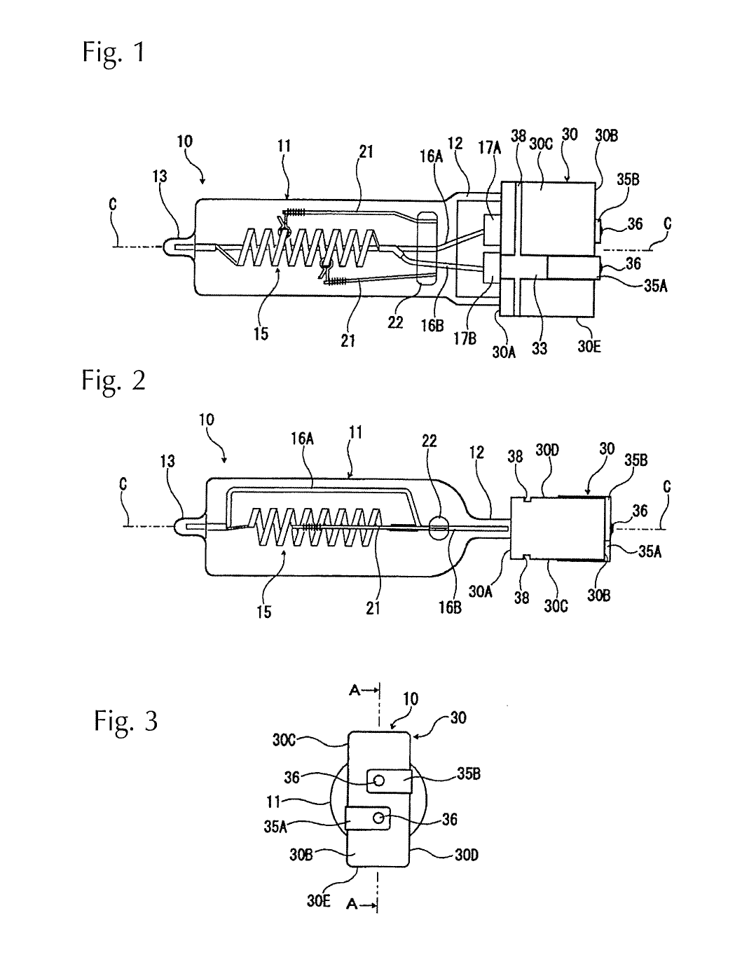

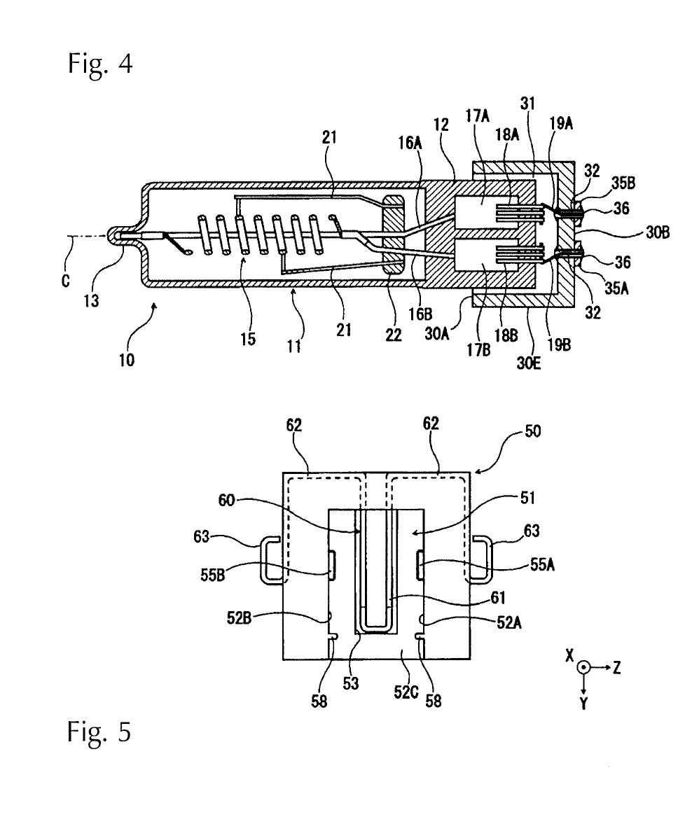

FIG. 1 is a front view schematically showing the configuration of an example of a single end type lamp of the present invention, FIG. 2 is a plan view of the single end type lamp shown in FIG. 1, FIG. 3 is a view of the right side of the single end type lamp shown in FIG. 1, and FIG. 4 is a section along A-A in FIG. 3. For convenience, one wide peripheral side face of the four peripheral side faces of the base extending along the tube axis of the light emitting tube will be referred to as the ‘flat front face’ in the present specification while the other one will be referred to as the ‘flat back face’.

The single end type lamp (in the following simply referred to as ‘lamp’) 10 is provided with a light emitting tube 11 made from, e.g., quartz glass. At one end thereof a flat sealing portion 12 is formed by means of a pinch seal while the other end has a vent pipe remnant 13. At one end of the light emitting tube 11 a base 30 made from ceramics such as alumina is secured such that the sealing portion 12 is accommodated and held therein. In the light emitting tube 11 a filament 15 formed by helically winding a wire from, e.g., tungsten is arranged such that the winding axis extends along the tube axis C of the light emitting tube 11 and an inert gas containing, for example, nitrogen and a halogen compound are enclosed. One end of the filament 15 is connected to an end side part of one internal lead rod 16A while the other end is connected to an end side part of another internal lead rod 16B. The other ends of the one internal lead rod 16A and the other internal lead rod 16B are connected respectively to the end side parts of a metal foil 17A and another metal foil 17B being buried air-tightly in the sealing portion 12 of the light emitting tube 11. One end side part of a plurality of external lead rods 18A extending such that they project outward in the direction of the tube axis from the other end face of the light emitting tube 11 is connected to the other end side part of the one metal foil 17A while the other ends of the external lead rods 18A are connected to a common rod-shaped connector element 19A. Further, one end side part of a plurality of external lead rods 18B extending such that they project outward in the direction of the tube axis from the other end face of the light emitting tube 11 is connected to the other end side part of the one metal foil 17B while the other ends of the external lead rods 18B are connected to a common rod-shaped connector element 19B. The reference numeral 21 in FIGS. 1, 2 and 4 refers to supporters holding the filament. The other end portions thereof are fixed to an insulating element (a glass piece) 22 holding and fixing the one internal lead rod 16A and the other internal lead rod 16B.

The base 30 is configured, as a whole, in the shape of a flat cuboid and has a holding part 31 which has the shape of a square column and is open at one end face 30A in the direction of the tube axis of the light emitting tube 11. It is fixed by means of, for example, an adhesive (not shown) at the sealing portion 12 of the lamp 10 in a state wherein a part of the sealing portion 12 of the light emitting tube 11 is attached by insertion into the holding part 31. At the other end face 30B of the base 30 in the direction of the tube axis of the light emitting tube 11, the tip ends of the two connector elements 19A, 19B project outward via throughholes 32 formed in the other end wall of the base 30, and contact point plates 35a, 35B made from, for example, nickel-plated brass are connected and fixed to the tip end of each connector element 19A, 19B by means of, for example, spot welding or silver soldering, thus connection parts 36 being formed. The contact point plates 35A, 35B are configured such that they extend in opposite directions, are bent at the corners of the other end face 30B of the base, and extend along said tube axis C while being positioned respectively in contact point plate arrangement grooves 33 which are formed such that they extend along the tube axis C of the light emitting tube 11 at the flat front face 30C and at the flat back face 30D of the base 30.

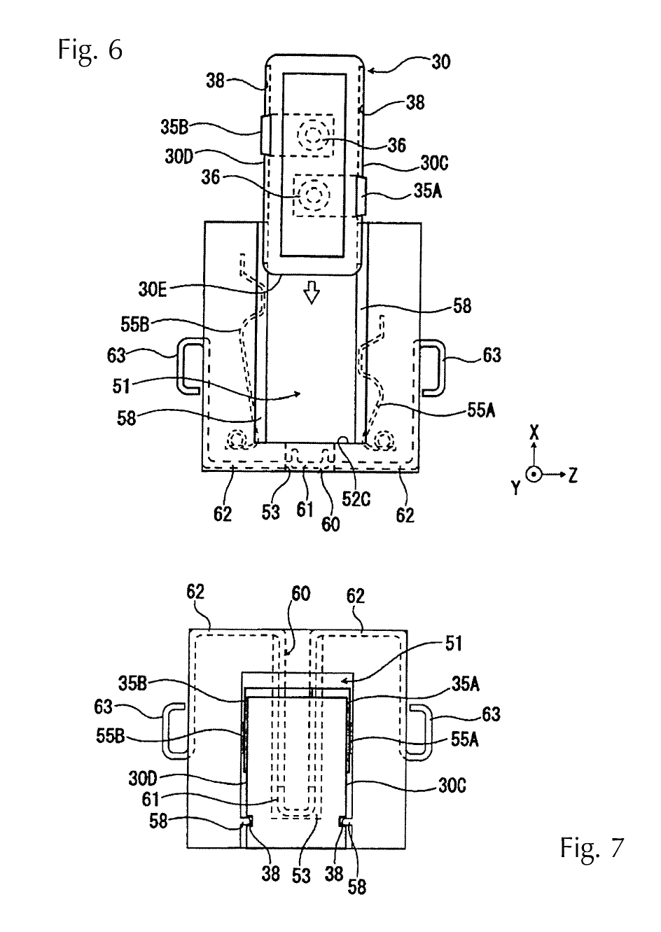

As is shown in FIGS. 5 and 6, this lamp 10 is configured such that the base 30 is attached removably by insertion in a direction being orthogonal to the tube axis C of the light emitting tube 11 into a concave accommodating portion 51 of a socket 50 being provided with this concave accommodating portion 51 to accommodate and hold the base 30. For convenience, in the following the directions X, Y and Z being shown in FIGS. 5 and 6 will be defined as ‘upward’, ‘forward’ and ‘rightward’ respectively.

The socket 50 has, as a whole, an approximately cuboid shape and is provided with the concave accommodating portion 51 forming a square columnar space which is open at the front face and the adjacent upper face region. At two opposing side walls 52A, 52B of the concave accommodating portion 51 which oppose the flat front face 30C and the flat back face 30D when the lamp is attached, contact point type power supply elements 55A, 55B are provided such that a portion thereof is exposed to the interior space of the concave accommodating portion 51, and engaging portions 58 consisting of projecting strips extending in the lamp insertion direction (the vertical direction) are formed.

This socket 50 is provided with a pin lever 60 for the removal of the attached lamp 10. The pin lever 60 is made by deforming a metal wire and comprises an approximately U-shaped central arm portion 61 extending along the bottom face 52C of the concave accommodating portion 51 in the fore-and-aft direction, the tip end portion thereof being curved arcuately, lateral beam portions 62 being connected to both ends of the central arm portion 61 and extending outward in parallel with the bottom face 52C of the concave accommodating portion 51, and lever portions 63 being connected to the lateral beam portions 62 the tip ends thereof extending obliquely upward and forward. The lateral beam portions 62 are held rotatably by a sleeve portion 65 being provided at the rear lower edge position of the socket 50 and the lever portions 63 are provided such that they are exposed to the outside (see FIG. 9). When the lamp is attached, the central arm portion 61 is accommodated in an upwardly open recess 53 being formed in the bottom wall which forms the concave accommodating portion 51.

At the base 30 of the lamp 10 of this example, an engaging part consisting of a concave groove 38 extending in a direction orthogonal to the tube axis C of the light emitting tube 11 is formed at each of the flat front face 30C and the flat back face 30D. When the lamp 10 is attached, said concave grooves 38 engage in the direction of the tube axis of the light emitting tube 11 slidably with the projecting strips of the concave accommodating portion 51 of the socket 50.

Below, the method of attaching the lamp 10 at the socket 50 and the method of removing it from the socket 50 will be explained.

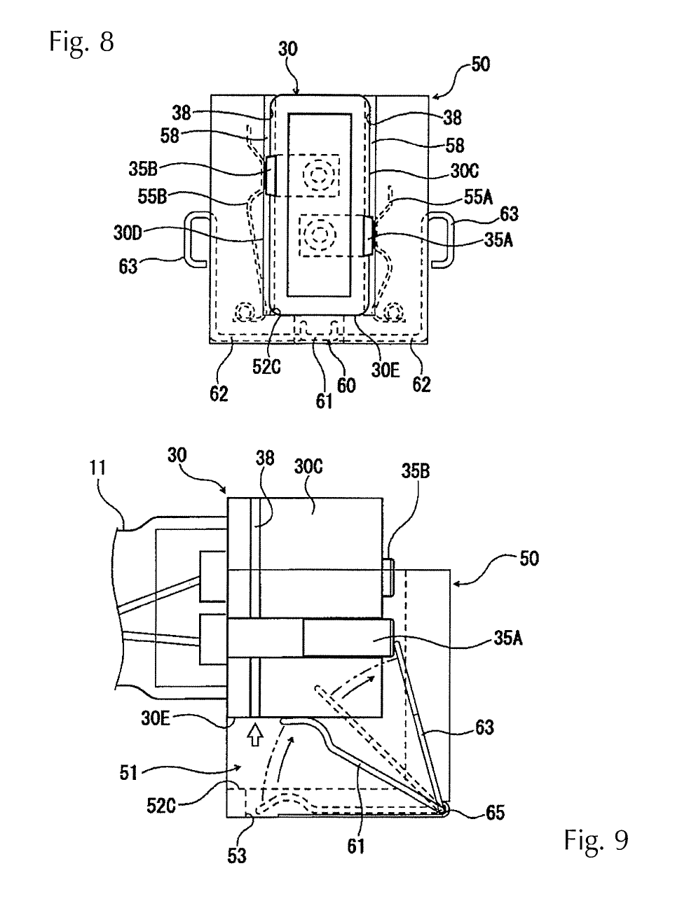

The lamp 10 is attached as follows: The concave grooves 38 of the base 30 are aligned with the projecting strips 58 of the concave accommodating portion 51 of the socket 50 while the tube axis C of the light emitting tube 11 extends in parallel with the bottom face 52C of the concave accommodating portion 51 of the socket 50. One narrow peripheral side face of the base 30 along the tube axis C of the light emitting tube 11 is inserted as an insertion head face 30E from above in a direction orthogonal to the tube axis C of the light emitting tube 11 (shown by the white arrow in FIG. 6) into the concave accommodating portion 51 of the socket 50 and the whole structure is engaged while the concave grooves 38 of the base 30 are being guided along the projecting strips 58 of the socket 50. As is shown in FIGS. 7 and 8, the insertion head face 30E of the base 30 is brought into contact with the bottom face 52C of the concave accommodating portion 51 of the socket 50 (surface contact) and the contact point plates 35A, 35B at the base 30 are connected electrically to the power supply elements 55A, 55B of the socket 50.

When the lamp 10 is to be removed from the socket 50, the central arm portion 61 is rotated about the lateral beam portions 62 by pressing the lever portions 63 of the pin lever 60 of the socket upwards (by turning them clockwise in FIG. 9), and is brought into contact with the insertion head face 30E of the base 30 of the lamp 10 so that the lamp 10 as a whole is pressed upwards. By means of this the insertion back face of the base 30 is made to project from the upper end face of the socket and the side portions of this insertion end face side can be gripped by the fingers and can be pulled out.

As, according to the above mentioned lamp 10, the concave grooves 38 of the flat front face 30c and the flat back face 30D of the base 30 are engaged while being guided along the projecting strips 58 of the concave accommodating portion 51 of the socket 50 by inserting the base 30 in a direction orthogonal to the tube axis C of the light emitting tube 11 into the concave accommodating portion 51 of the socket 50 being provided with this concave accommodating portion 51 to accommodate and hold the base 30, the lamp 10 can be easily attached at the socket 50 while the filament 15 is oriented correctly. As, further, a rotation along the lateral axis of the lamp and in the plane (X-Y plane) along the flat front face 30C (flat back face 30D) can be avoided, it is possible to attach the lamp 10 securely in the correct position.

Above, an embodiment of the present invention has been explained but the present invention is not limited to this above mentioned embodiment and a variety of alterations can be added.

For example, the above mentioned embodiment is configured such that engagement parts which consist of concave grooves to be attached at the socket wherein engaging portions consisting of projecting strips are formed in the concave accommodating portion, and which engage slidably with the projecting strips of the socket are formed in the base, but the same results as above can be obtained also with a configuration wherein engagement parts which consist of projecting strips to be attached at the socket wherein engaging portions consisting of concave grooves are formed in the concave accommodating portion, and which engage slidably with the concave grooves of the socket are formed at the base.

Further, a configuration is possible wherein a convex part (a projecting strip) is formed at one and a concave part (a concave groove) is formed at the other of the flat front face and the flat back face of the base.

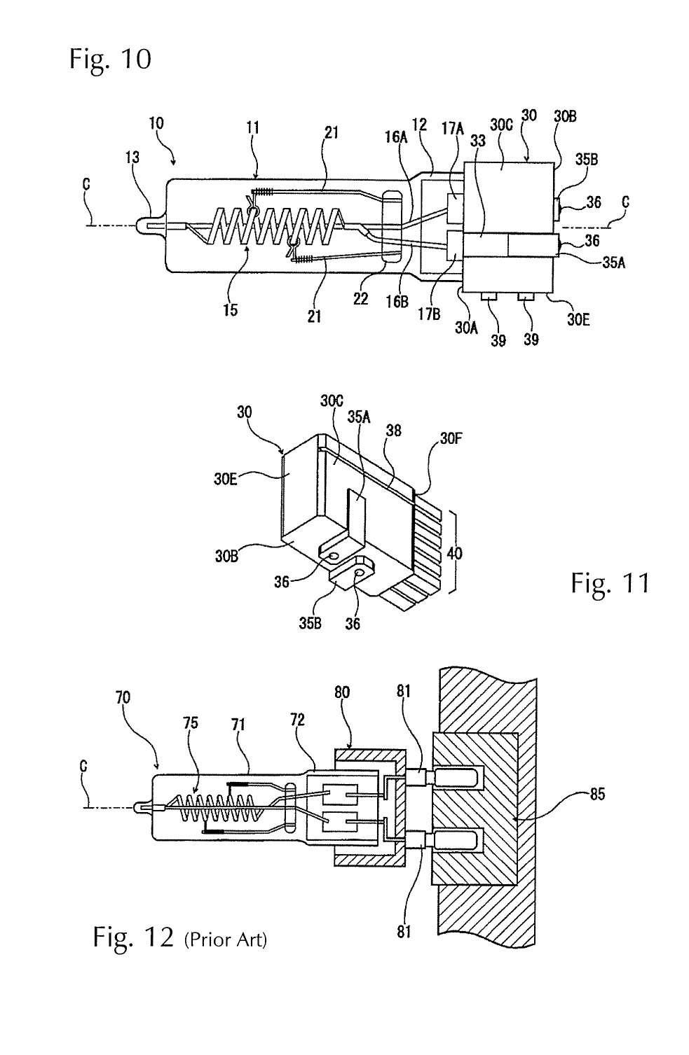

As is shown in FIG. 10, the engaging parts of the base can also be formed in the insertion head face 30E of the base 30 which contacts the bottom face of the concave accommodation portion of the socket. In this example, two columnar engagement projections 39 are formed side by side in the direction of the tube axis of the light emitting tube 11 at the insertion head face 30E of the base 30 and the attachment is made in a socket wherein recesses engaging with the engagement projections 39 at the base 30 are formed in the bottom face 52C of the concave accommodating portion 51 instead of the projecting strips 58 at the socket 50 shown in FIG. 5.

As also with a lamp 10 being configured in this way the engagement projections 39 at the base 30 and the recesses (engaging portions) at the concave accommodating portion of the socket become mutually engaged in the direction of the tube axis of the light emitting tube by inserting the base 30 in a direction being orthogonal to the tube axis C of the light emitting tube 11 into the concave accommodating portion of the socket, it suffices to move the lamp 10 in a direction being orthogonal to the tube axis C of the light emitting tube 11 when attaching or removing the lamp. Therefore, the lamp 10 can be attached at the socket easily and securely with the correct orientation.

Further, as is shown in FIG. 11, also a configuration is possible wherein heat-radiating fins 40 are provided at the base 30. At this base 30 a plurality of heat-radiating fins 40 is provided at the other narrow peripheral side face 30F (the circumferential face being opposite to the insertion head face 30E) which extends along the tube axis C of the light emitting tube 11. By means of such a configuration, it is possible to effect the radiation of heat from the lamp holding part effectively and to reduce the possibility that an overheated condition is reached. The heat-radiating fins 40 can be formed integrally but also a configuration wherein only the fin portion is formed and then attached is possible.

What is claimed is:

1. A single end type lamp comprising:
a light emitting tube with a sealing portion formed at one end thereof;
a base secured at one end of the light emitting tube and accommodating and holding the sealing portion;
a socket provided with a concave accommodating portion for removably accommodating and holding said base;
wherein said concave accommodating portion is arranged in said socket such that said base can be inserted therein in a direction orthogonal to a tube axis of the light emitting tube, and
the base is provided with an engaging part engaging at least in the direction of the tube axis of the light emitting tube with an engaging portion formed in said concave accommodating portion of said socket.

2. The single end type lamp according to claim 1, wherein said base is a flat cuboid, at least a portion of a flat front face and a flat back face thereof being provided with a contact point plate,
wherein said engaging part consists of one of a convex part and a concave part formed at each of said flat front face and said flat back face such as to extend in a direction orthogonal to the tube axis of said light emitting tube, and
the engaging portion of the socket consists of one of a concave part and a convex part extending in an insertion direction of the base into the socket at each of the faces in the concave accommodating portion opposing the flat front face and the flat back face of the base.

3. The single end type lamp according to claim 2, wherein the engaging part of said base is comprised of concave grooves being formed such that they extend in a direction orthogonal to the tube axis of said light emitting tube, and the engaging portion of the socket consists of projecting strips provided in the concave accommodating portion opposing a respective one of the flat front face and the flat back face of the base and engaging slidably with a respective one of said concave grooves of said base when the base is inserted into said concave accommodating portion.

4. The single end type lamp according to claim 2, wherein the engaging part of said base is comprised of projecting strips being formed such that they extend in a direction orthogonal to the tube axis of said light emitting tube, and the engaging portion of the socket consists of concave grooves provided in the concave accommodating portion opposing a respective one of the flat front face and the flat back face of the base and engaging slidably with a respective one of said projecting strips of said base when the base is inserted into said concave accommodating portion.

5. The single end type lamp according to claim 1, wherein said base is comprised of a flat cuboid, at least a portion of a flat front face and a flat back face thereof being provided with a contact point plate, wherein said engaging part consists of one of a convex part and a concave part formed in an insertion head face which comes to lie opposite a bottom face of the concave accommodating portion of said socket when the base is inserted into the socket, and the engaging portion of the socket consists of one of a concave part and a convex part formed in the bottom face of said concave accommodating portion.
